(19) United States
(12) Patent Application Publication
(10) Pub. No.: US 2008/0128356 A1
(43) Pub. Date: Jun. 5, 2008

(54) Three in One Method and Equipment for Treating Drinking Water

(76) Inventor: Kang Chen Sieh, Jiangsu (CN)

Correspondence Address: CARSTENS & CAHOON, LLP, P O BOX 802334, DALLAS, TX, 75380, US

(21) Appl. No.: 11/814,145

(22) PCT Filed: Dec. 15, 2005
(86) PCT No.: PCT/CN05/02193

§ 371 Date: Jul. 17, 2007

(30) Foreign Application Priority Data
Jan. 28, 2005 (CN) 200510038277.4

(51) Int. Cl. C02F 9/08; C02F 1/78; C02F 1/32; B01D 61/14

(52) U.S. Cl. 210/638; 210/192

(57) ABSTRACT

The present invention provides a three in one method and equipment for treating drinking water. The method comprises procedures of: pre-treatment, mixing active oxygen with water, photochemical oxidation and de-oxidation, ceramic membrane ultra filtering, and back flushing. The present invention advantageously makes use of combination of the active oxygen, UV rays, argil and other substances in nature to treat water so as to obtain the naturally purified drinking water.

### TECHNICAL FIELD

The present invention relates to a method and equipment for treating drinking water, particularly to a three in one method and equipment for treating drinking water.

### BACKGROUND ART

The methods for purifying water and removing bacteria currently involve boiled water, distilled water, purified water filtered by reverse osmosis, and purified water or pure water produced by ion-exchange or electro-dialysis. However, all of the above methods are not satisfying. Since the inorganic and organic pollutants could not be thoroughly removed from the boiled water, long term use of the boiled water would do harm to the human health. Distilled water will result in loss of minerals, while still contains cancerogenic chlorides and has a high production cost. Purified water filtered by reverse osmosis has bad taste, contains no minerals and rare elements, and 75% of water sources is wasted while it is produced. Water produced by ion-exchange contains too high level of sodium, has bad taste, and a thorough sterilization is not ensured. Pure water produced by electro-dialysis has a high production cost, wastes water sources, and has a bad taste. For billions of years, surface water purified by air, sunlight and sand stones in nature is the most healthy drinking water for human beings. This kind of water is the object that scientists in the world have been looking for and attempting to achieve. The active oxygen (O₃) present in air, called as ozone, is generally used to treat the industrial wastewater, and in drinking water industry it is mainly used as sterilization means to prevent from secondary pollution, for it is strongly corrosive, readily degradable and it is difficult to regulate the dosage when the water quality and the water amount vary. Although it possesses microbicidal abilities, the ultraviolet rays UV in sunlight are not able to remove organic and inorganic pollutants from water. Even though in the 1990s the use of combination of UV and O₃ was found to generate excellent synergistic effect, the combination of UV and O₃ was only applied to treat the industrial waste water, but can not be used to treat drinking water with strict requirements because it can not ensure a thorough sterilization and it can not be used in combination with organic fiber (ultra filtering) and organic membrane (RO reverse osmosis). Conventional methods employ ceramic membrane for filtering, in use the filtering core gets blocked easily, especially gets immediately blocked if organic pollutants are present while filtering, due to which back flushing could not be performed. Moreover, the cost for manufacture and use of the filtering core of ceramic ultra filtering membrane is so high that it can not be replaced frequently like the organic filtering core and organic membrane, which is a main obstacle for commercial operation of the ceramic membrane in the drinking water industry.

### SUMMARY OF THE INVENTION

In order to resolve the above defects, the present invention aims to provide a three in one method and equipment for treating drinking water, which utilizes the combination of ultraviolet light in sunlight, active oxygen in air and argil to treat the drinking water in a manner which is the most efficient and closest to nature.

The object of the present invention is carried out by the following technical solutions:

A three in one method for treating drinking water comprises procedures of: pretreatment, mixing active oxygen with water, photochemical oxidation and de-oxidation, ceramic membrane ultra filtering, and back flushing.

A three in one equipment for treating drinking water includes a raw water tank, a pre-filtration can, an activated carbon filter can, a fine filter can, a pipe, a valve, a back flushing system, an active oxygen generator, an active oxygen mixer, a UV generator, a photochemical oxidation and de-oxidation pipe and a ceramic membrane ultra filter; wherein the active oxygen generator is connected with the active oxygen mixer via a pipe; one end of the active oxygen mixer is connected with the fine filter via a pipe, and the other end of the active oxygen mixer is connected with one end of the photochemical oxidation and de-oxidation pipe; and wherein the photochemical oxidation and deoxidation pipe is positioned within the illumination area of the UV generator; and the other end of the photochemical oxidation and de-oxidation pipe is connected with the ceramic membrane ultra filter.

The object of the present invention is further carried out by the following technical solutions:

In the three in one method for treating drinking water as mentioned above, the procedure of mixing active oxygen with water is performed after the pre-treatment procedure and before the procedure of photochemical oxidation and deoxidation; and wherein the dosage of the active oxygen is 1-4 mg per liter of raw water at 15° C.-30° C. of the temperature of the raw water and 1-3 kgf/cm² of pressure of the raw water.

In the three in one method for treating drinking water as mentioned above, the procedure of photochemical oxidation and de-oxidation is performed before the procedure of ceramic membrane ultra filtering, and the excitation energy generated by the light energy is 90-140 kcal/mol or 376-585 kj/mol.

In the three in one method for treating drinking water as mentioned above, the procedure of back flushing is performed after the procedure of ceramic membrane ultra filtering, and the pressure of back flushing is 2-4 kgf/cm².

In the three in one equipment for treating drinking water as mentioned above, the active oxygen mixer is a mixture pump.

In the three in one equipment for treating drinking water as mentioned above, the outside wall of the photochemical oxidation and deoxidation pipe is coated with a layer of high molecular ceramic.

In the three in one equipment for treating drinking water as mentioned above, the layer of high molecular ceramic is coated on the outside wall of the photochemical oxidation and de-oxidation pipe which is the far side from the radiation source.

In the three in one equipment for treating drinking water as mentioned above, the layer of high molecular ceramic is made of the mixture of polyester (PET) resin or the polyethylene (PE) resin with tourmaline or medicinal stone “maifanshi” having a mean diameter lower than 100 nm, and the content of the polymer resin is 50-70% by weight, and the content of tourmaline or medicinal stone “maifanshi” is 30-50% by weight.

In the three in one equipment for treating drinking water as mentioned above, the inner ceramic filtering membrane of the ceramic membrane ultra filter has a hollow diameter of 0.01-0.5 μm.

The advantages of the present invention is in that, raw water is treated by making use of the combination of natural substances widely present in nature, such as active oxygen, ultraviolet rays and argil, to perform pure water treatment such that the treated water achieves the quality of natural drinking water.

The objects, advantages and properties of the present invention will be shown graphically and explained by the following preferred embodiments which are not limiting to the invention, wherein the embodiments are provided as examples by referring to the accompanying drawings.

### BRIEF DESCRIPTION OF THE DRAWINGS

FIG. 1 is a schematic view showing the procedures of the method of the present invention;

FIG. 2 is a schematic view showing the equipment of the present invention;

FIG. 3 is a schematic view showing the surface structure of the photochemical oxidation and de-oxidation pipe in the present invention.

### DETAIL DESCRIPTION OF THE PREFERRED EMBODIMENTS

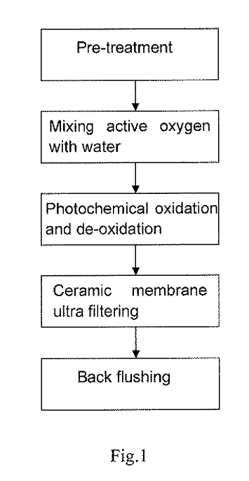

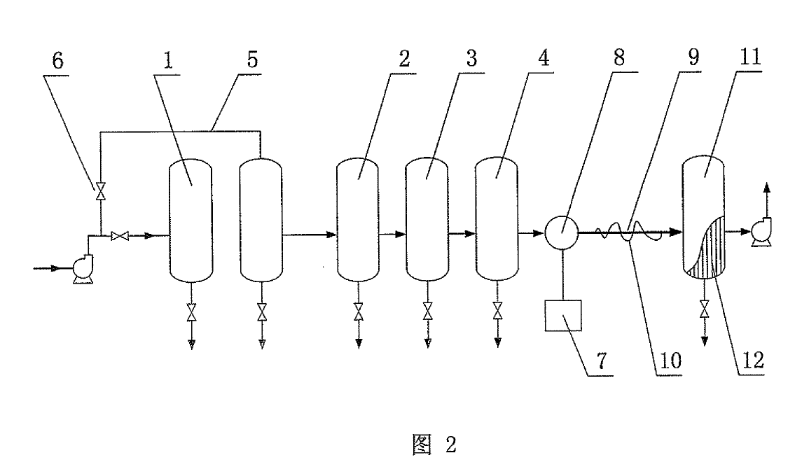

As shown in FIGS. 1 and 2, the three in one equipment for treating drinking water according to the present invention includes a raw water tank 1, a pre-filtration can 2, an activated carbon filter can 3, a fine filter can 4, a pipe 5 and a valve 6. The equipment further comprises an active oxygen generator 7, an active oxygen mixer 8, a UV generator 9, a photochemical oxidation and de-oxidation pipe 10, a ceramic membrane ultra filter 11, wherein the active oxygen generator 7 is connected with the active oxygen mixer 8 via a pipe. One end of the active oxygen mixer 8 is connected with the fine filter 4 via a pipe, and the other end thereof is connected with one end of the photochemical oxidation and deoxidation pipe 10. The photochemical oxidation and de-oxidation pipe 10 is positioned within the illumination area of the UV generator 9. The other end of the photochemical oxidation and deoxidation pipe 10 is connected with the ceramic membrane ultra filter 11. The active oxygen mixer is a mixture pump (Model: USESE 20 QY2.5). Raw water is pumped into the raw water tank 1 by a pump and passes through the pre-filtration can 2, the activated carbon filter can 3 and the fine filter can 4 in order via the pipe 5 so as to complete a pretreatment procedure. The pretreated water again enters the active oxygen mixer 8, where the active oxygen (O₃) generated by the active oxygen generator 7 also enters the active oxygen mixer 8 and mixes with water, wherein the dosage of the active oxygen is 1-4 mg per liter of raw water at 15° C.-30° C. of the raw water and 1-3 kgf/cm² of the pressure of the raw water. Completing the procedure of mixing active oxygen with water, the mixed water enters the photochemical oxidation and de-oxidation pipe 10, in which, under the action of the UV generator 9 which generates 90-140 kcal/mol or 376-585 kj/mol of excitation energy, the active oxygen added in the previous procedure carries out anaerobic reaction in water to remove the anaerobic bacteria in water, at the same time, ultraviolet rays (UV) further sterilizes water and enhances the function of oxidation and deoxidation of the active oxygen such that exhaustive photochemical oxidation and de-oxidation reaction is made. Finishing the procedure of photochemical oxidation and de-oxidation, water enters the ceramic membrane ultra filter 11 via a pipe, wherein the procedure of the ceramic membrane ultra filtering is performed before the procedure of photochemical oxidation and de-oxidation and the inner ceramic filtering membrane 12 has a hollow diameter of 0.01-0.5 μm. Thanks to use of the ceramic ultra filtering membrane, the residual dead bacteria sterilized by UV in the procedure of photochemical oxidation and de-oxidation are filtered out such that water flowing out has good taste and decreases the chance of secondary pollution. The ceramic ultra filtering membrane filters out the organic and inorganic pollutants reduced by O₃ in the form of reduced solid such that water flowing out has better taste and harms by the pollutants to human bodies are lessened. The ceramic ultra filtering membrane 12 thoroughly filters out the bacteria and viruses which can not be sterilized completely by UV and O₃.

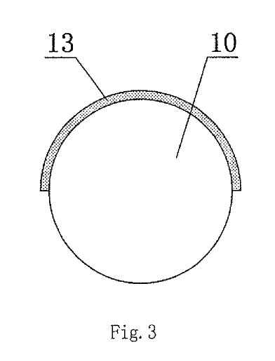

To achieve better application effect and generate more negative ions, in the three in one equipment for treating drinking water according to the present invention, the outside wall of the photochemical oxidation and de-oxidation pipe 10 which is the far side from the radiation source can be coated with a layer of high molecular ceramic, as shown in FIG. 3. When the photochemical oxidation and deoxidation pipe 10 is used in multi-layer winding, a layer of high molecular ceramic 13 is simply coated on the outside of the outermost layer of the pipe; When the photochemical oxidation and de-oxidation pipe 10 is used in only one single layer, the layer of high molecular ceramic 13 should be coated on the outside wall of the pipe which is the far side from the radiation source. Here, the layer of high molecular ceramic 13 may be made of mixture of polyester (PET) resin or the polyethylene (PE) resin with tourmaline or medicinal stone “maifanshi” having a mean diameter lower than 100 nm, wherein the content of the polymer resin is 50-70% by weight, and the content of tourmaline or medicinal stone “maifanshi” is 30-50% by weight. It is preferred that the weight proportion of polymer resin is two-third and the weight proportion of tourmaline or medicinal stone “maifanshi” is one-third.

After the equipment is used for a period of time, the ceramic ultra filter can be subjected to back flushing by a back flushing system, in which the pressure of back flushing is 2-4 kgf/cm². Due to the combination of the above mentioned procedures, more than 96% organic pollutants in water are changed into carbon, water, oxygen, carbon dioxide and OH⁻, and the entrapped organic pollutants adsorbed onto the ceramic membrane are reduced into solids, thus changing the organic pollutants in water so as to make them lose adhesive force and agglomerating force, such that the reduced solids are easily removed from the ceramic ultra filter when the ceramic ultra filtering membrane is subjected to back flushing, thus resolving the problem that the ceramic membrane with high density is easily blocked and can not be applied commercially.

Along with the embodiments mentioned above, the present invention is also available in other embodiments, that is, any technical schemes with same functions but in any of different forms are within the protection scope of the present invention defined in the attached claims.

1. A three in one method for treating drinking water comprising procedures of: pretreatment mixing active oxygen with water, photochemical oxidation and de-oxidation, ceramic membrane ultra filtering, and back flushing.

2. The three in one method for treating drinking water according to claim 1, wherein the procedure of mixing active oxygen with water is performed after the pre-treatment procedure and before the procedure of photochemical oxidation and de-oxidation, and the dosage of the active oxygen is 1-4 mg per liter of raw water at 15° C.-30° C. of the temperature of the raw water and 1-3 kgf/cm² of pressure of the raw water.

3. The three in one method for treating drinking water according to claim 1, wherein the procedure of photochemical oxidation and de-oxidation is performed before the procedure of ceramic membrane ultra filtering, and the excitation energy generated by the light energy is 90-140 kcal/mol or 376-585 kj/mol.

4. The three in one method for treating drinking water according to claim 1, wherein the procedure of back flushing is performed after the procedure of ceramic membrane ultra filtering and the pressure of back flushing is 2-3 kgf/cm².

5. A three in one equipment for treating drinking water including a raw water tank, a pre-filtration can, an activated carbon filter can, a fine filter can, a pipe, a valve, a back flushing system, an active oxygen generator, an active oxygen mixer, a UV generator, a photochemical oxidation and de-oxidation pipe and a ceramic membrane ultra filter; wherein the active oxygen generator is connected with the active oxygen mixer via a pipe; one end of the active oxygen mixer is connected with the fine filter via a pipe, and the other end of the active oxygen mixer is connected with one end of the photochemical oxidation and deoxidation pipe; and wherein the photochemical oxidation and de-oxidation pipe is positioned within the illumination area of the UV generator; and the other end of the photochemical oxidation and de-oxidation pipe is connected with the ceramic membrane ultra filter.

6. The three in one equipment for treating drinking water according to claim 5, wherein the active oxygen mixer is a mixture pump.

7. The three in one equipment for treating drinking water according to claim 5, wherein the outside wall of the photochemical oxidation and de-oxidation pipe is coated with a layer of high molecular ceramic.

8. The three in one equipment for treating drinking water according to claim 7, wherein the layer of high molecular ceramic is coated on the outside wall of the photochemical oxidation and de-oxidation pipe which is the far side from the radiation source.

9. The three in one equipment for treating drinking water according to claim 7 or 8, wherein the layer of high molecular ceramic is made of the mixture of polyester (PET) resin or the polyethyene (PE) resin with tourmaline or medicinal stone “maifanshi” having a mean diameter lower than 100 nm, and wherein the content of the polymer resin is 50-70% by weight, and the content of tourmaline or medicinal stone “maifanshi” is 30-50% by weight.

10. The three in one equipment for treating drinking water according to claim 5, wherein the inner ceramic membrane in the ceramic membrane ultra filter has a hollow diameter of 0.01-0.5 μm.
